(19) United States
(12) Patent Application Publication
(10) Pub. No.: US 2009/0159540 A1
(43) Pub. Date: Jun. 25, 2009

(54) APPARATUS AND METHOD FOR SUPPORTING AN OBJECT SUCH AS A RIFLE

(76) Inventor: Paul Meeks, Tallulah, LA (US)

Correspondence Address: HAYNES AND BOONE, LLP;IP Section, 2323 Victory Avenue, Suite 700, Dallas, TX, 75219, US

(21) Appl. No.: 11/963,224

(22) Filed: Dec. 21, 2007

(51) Int. Cl. B60R 7/14

(52) U.S. Cl. 211/64

(57) ABSTRACT

An apparatus and method according to which the apparatus is removably coupled to a structure such as a utility terrain vehicle (UTV), and the apparatus supports or carries an object such as a rifle, bow or treestand.

### BACKGROUND

The present disclosure relates in general to a support apparatus or carrier, and in particular to an apparatus and method for supporting or carrying an object such as a rifle, bow or treestand, the apparatus being adapted to be removably coupled to a structure such as a utility terrain vehicle (UTV).

### BRIEF DESCRIPTION OF THE DRAWINGS

FIG. 1 is a perspective view of a support apparatus according to an exemplary embodiment, with the support apparatus being removably coupled to a utility terrain vehicle (UTV) according to an exemplary embodiment.

FIG. 2 is an enlarged perspective view of a portion of the support apparatus of FIG. 1 according to an exemplary embodiment.

FIG. 3 is a perspective view of the support apparatus of FIGS. 1 and 2 according to an exemplary embodiment.

FIG. 4 is a perspective view of a component of the support apparatus of FIGS. 1, 2 and 3 according to an exemplary embodiment.

FIG. 5 is a sectional view of the component of FIG. 5 taken along line 5-5.

FIG. 6 is a perspective view of another component of the support apparatus of FIGS. 1, 2 and 3 according to an exemplary embodiment.

FIG. 7 is an elevational view of the support apparatus of FIGS. 1, 2 and 3 removably coupled to another structure according to an exemplary embodiment.

FIG. 8A is a simplified elevational view of the support apparatus of FIGS. 1, 2, 3 and 7 removably coupled to yet another structure according to an exemplary embodiment.

FIGS. 8B, 8C, 8D, 8E and 8F are views similar to that of FIG. 8A, but depicting the support apparatus of FIGS. 1, 2, 3 and 7 removably coupled to additional structures according to other exemplary embodiments.

### DETAILED DESCRIPTION

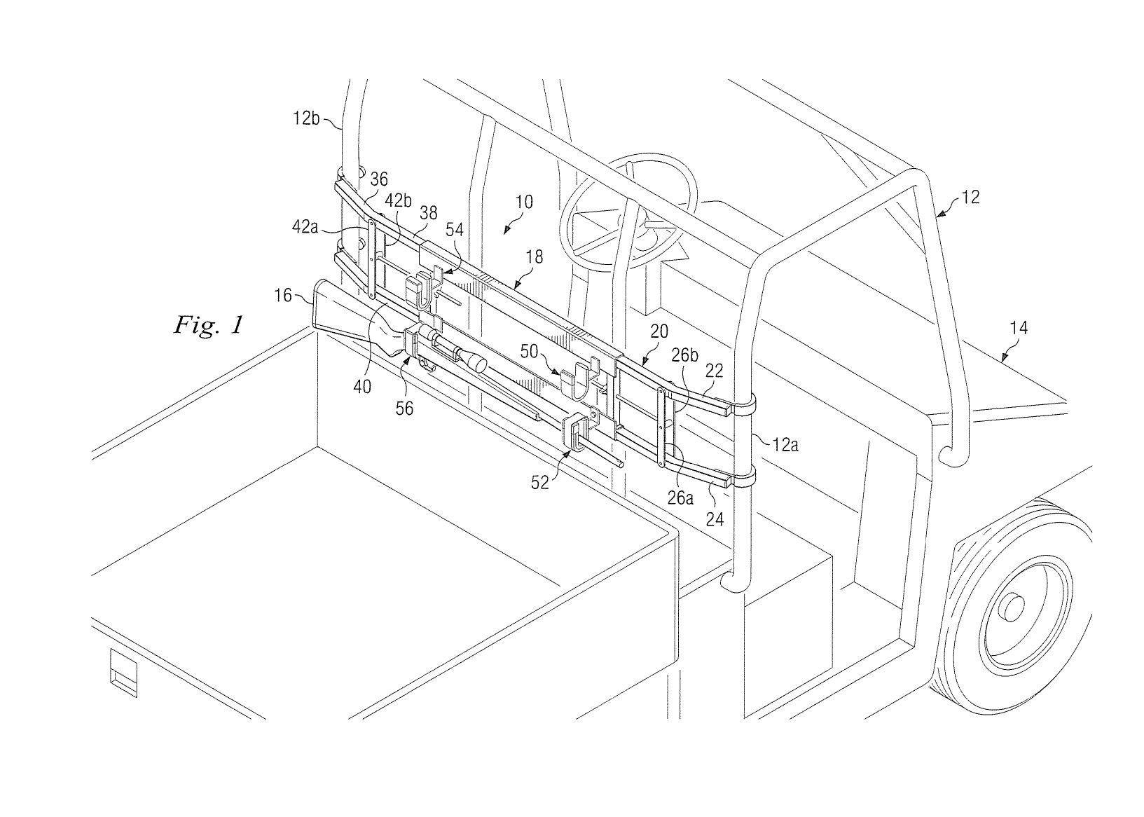

In an exemplary embodiment, as illustrated in FIG. 1, a support apparatus, or carrier, is generally referred to by the reference numeral 10 and is adapted to be removably coupled to a structure, such as a cab 12 of a utility terrain vehicle (UTV) 14. An object, such as a rifle 16, is supported by the apparatus 10.

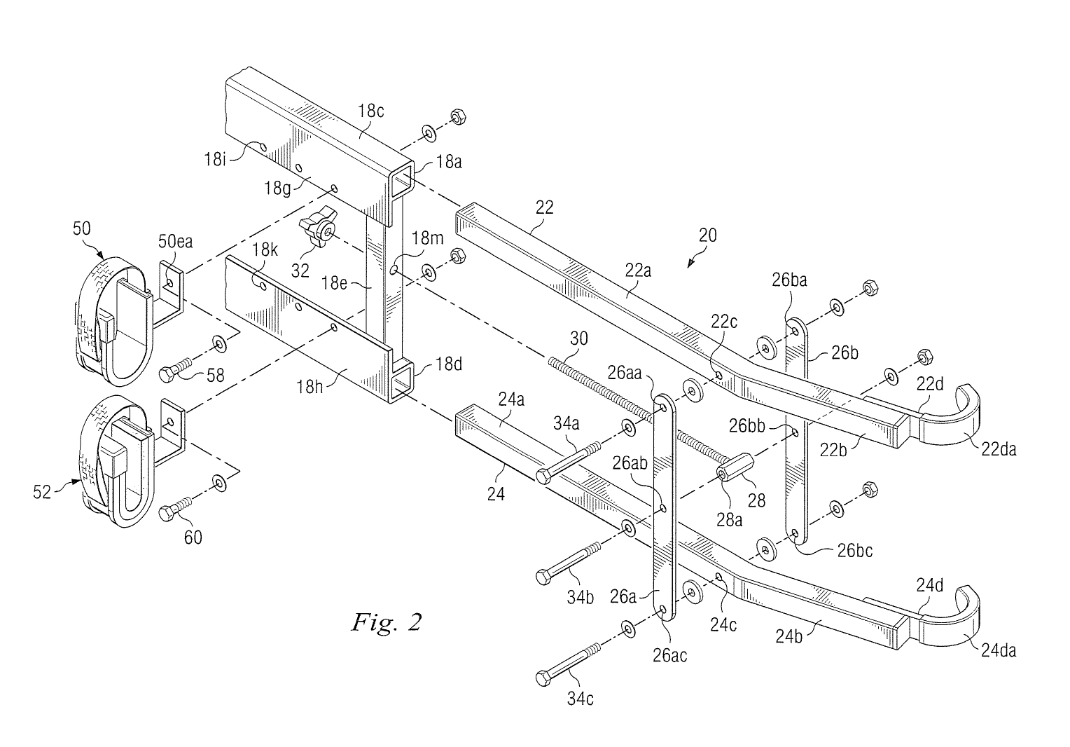

In an exemplary embodiment, as illustrated in FIGS. 1, 2 and 3, the apparatus 10 includes a frame 18 defining opposing end portions 18a and 18b and including sleeves 18c and 18d spaced in a parallel relation, and vertically-extending bars 18e and 18f spaced in a parallel relation and extending between the sleeves 18c and 18d. A plate 18g is coupled to the sleeve 18c and the bars 18e and 18f, and extends along the length of the sleeve 18c. Similarly, a plate 18h is coupled to the sleeve 18d and the bars 18e and 18f, and extends along the length of the sleeve 18d. The plates 18g and 18h are generally coplanar.

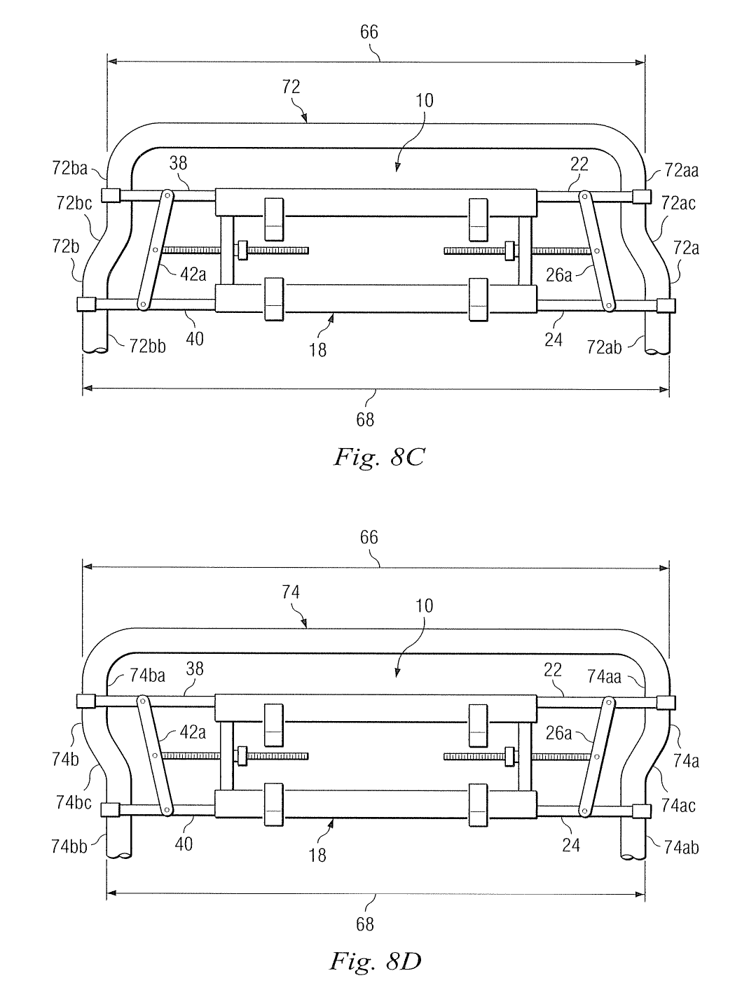

A plurality of through-openings 18i are formed through the plate 18g at the end portion 18a, and a plurality of through-openings 18j (shown in FIG. 7) are formed through the plate 18g at the end portion 18b. Similarly, a plurality of through-openings 18k are formed through the plate 18h at the end portion 18a, and a plurality of through-openings 18l are formed through the plate 18h at the end portion 18b. In several exemplary embodiments, instead of, or in addition the respective pluralities of through-openings 18i, 18j, 18k and/or 18l, one or more additional through-openings or pluralities of through-openings may be formed through the plates 18g and/or 18h at various locations therealong.

A through-opening 18m is formed through the bar 18e at about midway between the sleeves 18c and 18d. Although not shown in the figures, another through-opening substantially similar to, and axially aligned with, the through-opening 18m is formed through the bar 18f at about midway between the sleeves 18c and 18d.

An arm assembly 20 is coupled to the frame 18 at the end portion 18a and includes an arm 22 telescopingly engaged with the sleeve 18c, an arm 24 telescopingly engaged with the sleeve 18d, link members 26a and 26b coupled to the arms 22 and 24, a coupling 28 defining an internal passage 28a and coupled to the link members 26a and 26b, a threaded rod 30 extending from the coupling 28, and a wing knob 32 coupled to the distal end portion of the threaded rod 30.

The arm 22 includes a horizontally-extending portion 22a and an angular portion 22b extending therefrom. A through-opening 22c is formed through the horizontally-extending portion 22a proximate the proximal end portion of the angular portion 22b. A hook portion 22d extends from the distal end portion of the angular portion 22b and includes a hook-shaped cap 22da. In an exemplary embodiment, the hook-shaped cap 22da is composed of a rubber material. Similarly, the arm 24 includes a horizontally-extending portion 24a and an angular portion 24b extending therefrom. A through-opening 24c is formed through the horizontally-extending portion 24a proximate the proximal end portion of the angular portion 24b. A hook portion 24d extends from the distal end portion of the angular portion 24b and includes a hook-shaped cap 24da. In an exemplary embodiment, the hook-shaped cap 24da is composed of a rubber material. The link member 26a includes through-openings 26aa, 26ab and 26ac, and the link member 26b includes through-openings 26ba, 26bb and 26bc.

As noted above, the link members 26a and 26b are coupled to the arms 22 and 24 and the coupling 28. More particularly, a fastener 34a extends through the through-openings 26aa, 22c and 26ba, a fastener 34b extends through the through-openings 26ab, the internal passage 28a and the through-opening 26bb, and a fastener 34c extends through the through-openings 26ac, 24c and 26bc, thereby coupling the link members 26a and 26b to the arms 22 and 24 and the coupling 28.

As noted above, the arm assembly 20 is coupled to the frame 18 at the end portion 18a. More particularly, the threaded rod 30 extends from the coupling 28 and through the through-opening 18m, and the wing knob 32 is disposed between the sleeves 18c and 18d and is threadably engaged with the rod 30, thereby coupling the arm assembly 20 to the frame 18.

An arm assembly 36 is coupled to the frame 18 at the end portion 18b and includes an arm 38 telescopingly engaged with the sleeve 18c, an arm 40 telescopingly engaged with the sleeve 18d, link members 42a and 42b coupled to the arms 38 and 40, a coupling 44 defining an internal passage (not shown) and coupled to the link members 42a and 42b, a threaded rod 46 extending from the coupling 44, and a wing knob 48 coupled to the distal end portion of the threaded rod 46. The arm assemblies 20 and 36 are symmetric about a plane that is perpendicular to a plane in which the coplanar plates 18g and 18h lie. Since the arm assembly 36 is the symmetric equivalent to the arm assembly 20, the arm assembly 36 will not be described in further detail; the above-noted couplings between the arm assembly 36 and the frame 18, and among the above-noted components of the arm assembly 36, are substantially similar to the above-described corresponding couplings between the arm assembly 20 and the frame 18, and among the components of the arm assembly 20, respectively, and therefore will not be described in further detail.

A support 50 is coupled to the plate 18g of the frame 18 at the end portion 18a. A support 52 is coupled to the plate 18h of the frame 18 at the end portion 18a. A support 54 is coupled to the plate 18g of the frame 18 at the end portion 18b. A support 56 is coupled to the plate 18h of the frame 18 at the end portion 18b.

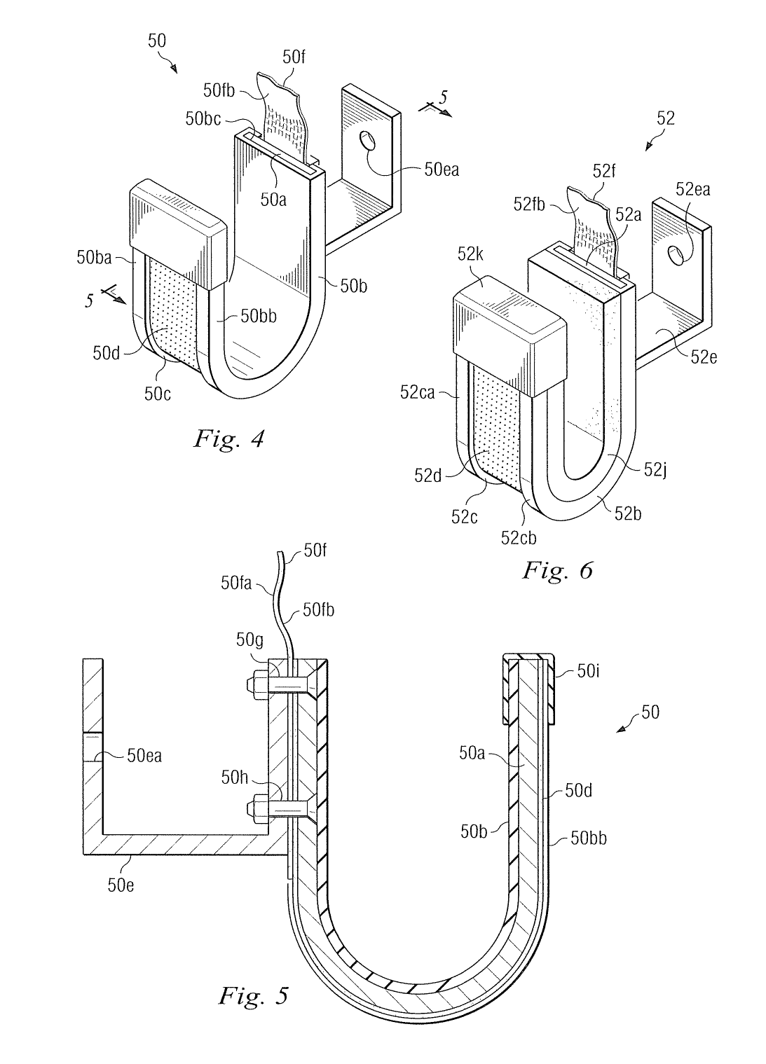

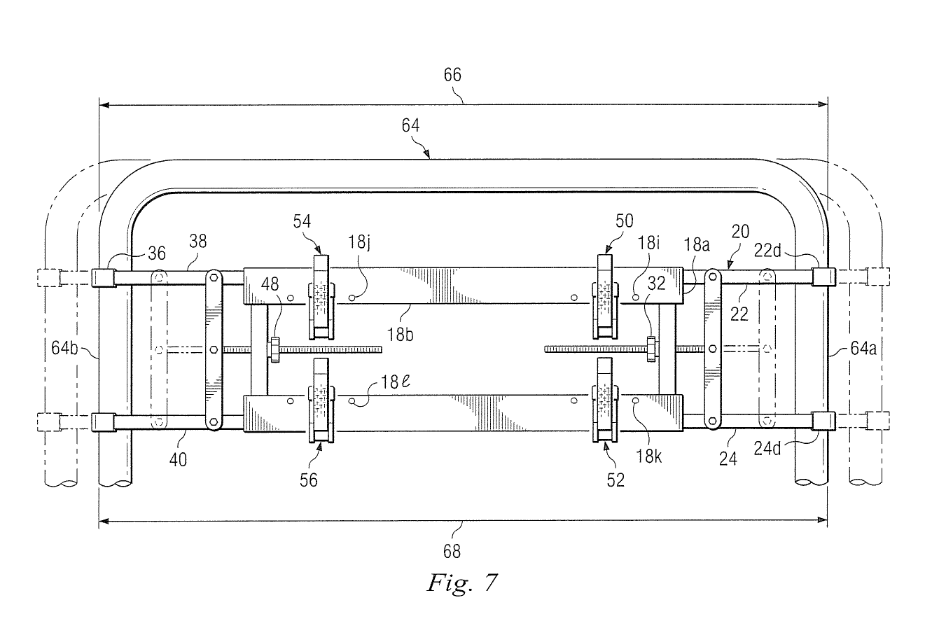

In an exemplary embodiment, as illustrated in FIGS. 4 and 5 with continuing reference to FIGS. 1, 2 and 3, the support 50 includes a U-shaped member 50a, and a track 50b including ridges 50ba and 50bb and defining a channel 50bc in which the U-shaped member 50a extends so that the inner and side surfaces of the U-shaped member 50a are covered by the track 50b. A channel 50c is defined by the outer surface of the U-shaped member 50a and the ridges 50ba and 50bb of the track 50b. A coupling strap 50d extends within the channel 50c and is coupled to the U-shaped member 50a. In an exemplary embodiment, the outer surface of the strap 50d includes Velcro® loop fasteners. A square-U-shaped bracket 50e including a through-opening 50ea is coupled to the U-shaped member 50a, and a coupling strap 50f defining surfaces 50fa and 50fb is disposed between, and coupled to, the U-shaped member 50a and the bracket 50e. Fasteners 50g and 50h extend through the U-shaped member 50a, the strap 50f and the bracket 50e, thereby coupling the components together. In an exemplary embodiment, the surface 50fb of the strap 50f includes Velcro® hook fasteners. A rubber cap 50i fits over the ends of the U-shaped member 50a, the track 50b and the strap 50d, which ends are opposite the bracket 50e.

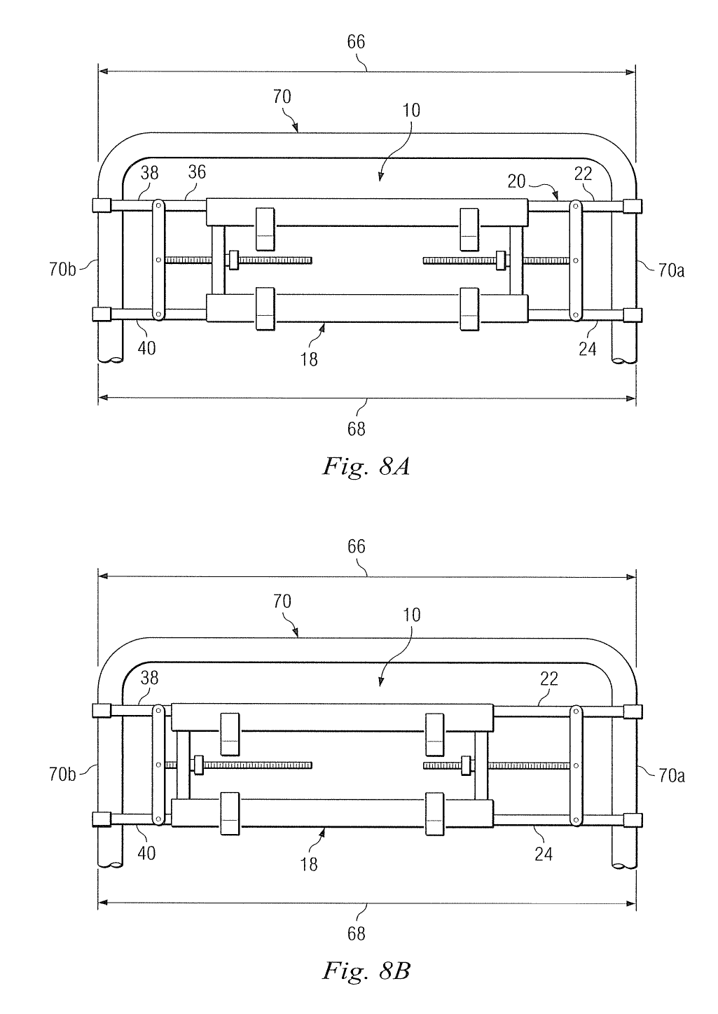

In an exemplary embodiment, as illustrated in FIG. 6 with continuing reference to FIGS. 1, 2, 3, 4 and 5, the support 52 includes components that are substantially identical to the above-described components of the support 50, and reference numerals used to refer to the components of the support 52 that are substantially identical to the components of the support 50 will correspond to the reference numerals used to refer to the components of the support 50, except that the numeric prefix for the reference numerals used to the describe the support 50, that is, 50, will be replaced by the numeric prefix of the support 52, that is, 52. The support 52 further includes a U-shaped foam pad 52j coupled to the surface of the track 52b opposite the channel 52c. Instead of a rubber cap substantially identical to the rubber cap 50i of the support 50, the support 52 includes a rubber cap 52k that is sized to fit over the ends of the U-shaped member 52a, the track 52b, the strap 52d and the foam pad 52j, which ends are opposite the bracket 52e.

In an exemplary embodiment, with continuing reference to FIGS. 1, 2, 3, 4, 5 and 6, and as noted above, the supports 50 and 52 are coupled to the plates 18g and 18h, respectively, of the frame 18. More particularly, a fastener 58 extends through the through-opening 50e a of the bracket 50e of the support 50, and through one of the through-openings 18i of the frame 18, thereby coupling the support 50 to the plate 18g of the frame 18. A fastener 60 extends through the through-opening 52ea of the bracket 52e of the support 52, and through one of the through-openings 18k of the frame 18, thereby coupling the support 52 to the plate 18h of the frame 18.

The support 56 is substantially identical to the support 50 and therefore will not be described in detail. The support 54 is substantially identical to the support 52 and therefore will not be described in detail. Respective fasteners (not shown) similar to the fasteners 58 and 60 couple the supports 54 and 56, respectively, to the plates 18g and 18h, respectively, in a manner substantially similar to the manner by which the fasteners 58 and 60 couple the supports 50 and 52, respectively, to the plates 18g and 18h, respectively.

In operation, to quickly removably couple the apparatus 10 to the cab 12 of the UTV 14, in an exemplary embodiment with continuing reference to FIGS. 1, 2, 3, 4, 5 and 6, the hook portions 22d and 24d of the arms 22 and 24, respectively, are engaged with a vertically-extending member or portion 12a of the cab 12, and the corresponding hook portions of the arms 38 and 40 are engaged with a vertically-extending member or portion 12b of the cab 12. To hold the apparatus 10 in place on the cab 12, and to securely removably couple the apparatus 10 to the cab 12, the wing knob 32 is rotated clockwise and tightened, thereby causing, or at least urging, the wing knob 32 to translate towards the bar 18e. After the wing knob 32 contacts the bar 18e, the wing knob 32 can no longer translate towards the bar 18e in response to the clockwise rotation and tightening of the wing knob 32. Instead, the arm assembly 20, including the arms 22 and 24, is pulled, or at least urged, towards the end portion 18a of the frame 18, thereby causing, or at least urging, the arms 22 and 24 to move relative to the frame 18 and telescope further into the sleeves 18c and 18d, respectively.

Instead of, or in addition to tightening the wing knob 32, the wing knob 48 is rotated clockwise and tightened, thereby causing, or at least urging, the wing knob 48 to translate towards the bar 18f. After the wing knob 48 contacts the bar 18f, the wing knob 48 can no longer translate towards the bar 18f in response to the clockwise rotation and tightening of the wing knob 48. Instead, the arm assembly 36, including the arms 38 and 40, is pulled, or at least urged, towards the end portion 18b of the frame 18, thereby causing, or at least urging, the arms 38 and 40 to move relative to the frame 18 and telescope further into the sleeves 18c and 18d, respectively.

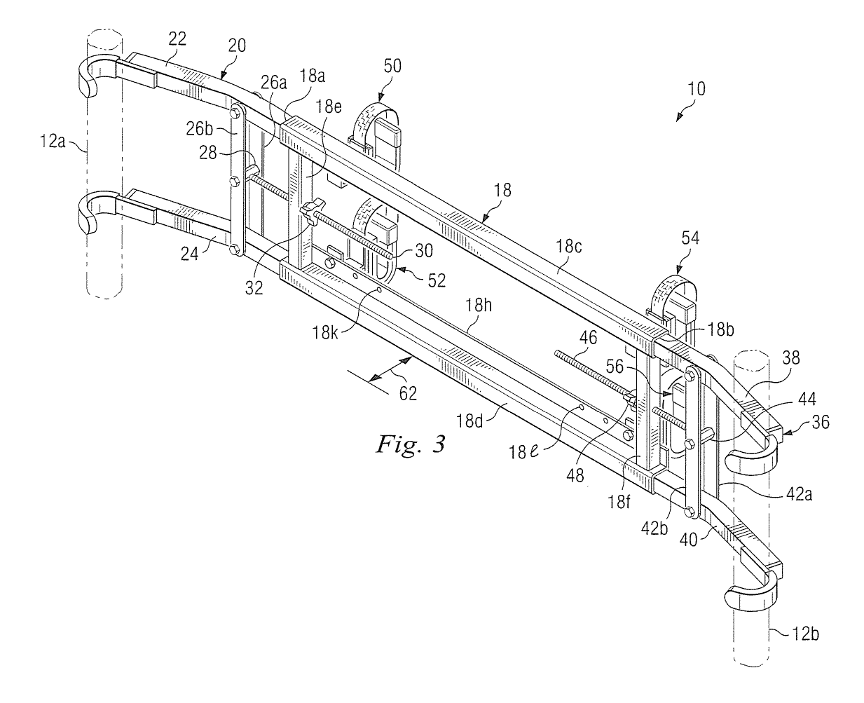

At some point during the continued clockwise rotation of the wing knobs 32 and/or 40, the portion 12a of the cab 12 resists any further urging and/or movement of the arms 22 and 24 towards the frame 18, and the portion 12b of the cab 12 resists any further urging and/or movement of the arms 38 and 40 towards the frame 18, thereby subjecting the apparatus 10 to tension loading. The tension-loaded apparatus 10 is thus held in place and securely removably coupled to the cab 12, as shown in FIG. 1. At this point, the distance between respective outer tangential points of the portions 12a and 12b of the cab 12 is generally equal to the distance between respective inner tangential points of the hook portion 22d of the arm 22 and the corresponding hook portion of the arm 38, and is generally equal to the distance between respective inner tangential points of the hook portion 24d of the arm 24 and the corresponding hook portion of the arm 40, as shown in FIG. 3.

In an exemplary embodiment, the angular portions 22b and 24b of the arms 22 and 24, respectively, and the respective angular portions of the arms 38 and 40, provide an offset 62 (shown in FIG. 3) between the frame 18 and the portions 12a and 12b of the cab 12, thereby providing any necessary clearance to enable a user to more easily manipulate the wing knobs 32 and 48, the frame 18 and/or the entire apparatus 10, relative to the cab 12, during the installation of the apparatus 10.

In an exemplary embodiment, during operation, to support or carry the rifle 16 using the apparatus 10, the barrel of the rifle 16 is disposed in the support 52 so that the barrel contacts the foam pad 52j and is supported by the support 52, and either the stock or another portion of the rifle 16 is disposed in the support 56 so that the stock or portion contacts the track 56b and is supported by the support 56. As a result, the rifle 16 is supported by the apparatus 10. The rifle 16 is secured in place by disposing the straps 52f and 56f over the rifle 16 and fastening the straps 52f and 56f to the straps 52d and 56d, respectively. In an exemplary embodiment, the respective engagements between the straps 52f and 56f, and the straps 52d and 56d, are Velcro®hook-and-loop engagements.

In an exemplary embodiment, the foam pad 52j and the track 56b reduce the likelihood of the respective supports 52 and 56 from scratching or otherwise damaging the rifle 16 while the rifle 16 is supported by the apparatus 10. In an exemplary embodiment, the apparatus 10 continues to support and hold the rifle 16 securely in place in the manner described above before, during and/or after any movement or travel of the UTV 14.

In an exemplary embodiment, to remove the rifle 16 from the apparatus 10, the straps 52f and 56f are disengaged from the straps 52d and 56d, respectively, and the rifle 16 is pulled up and out of the supports 52 and 56.

In an exemplary embodiment, instead of supporting the rifle 16 with the supports 52 and 56, the rifle 16 is supported with the supports 54 and 50 in a manner substantially similar to the above-described manner by which the rifle 16 is supported with the supports 52 and 56, respectively. In an exemplary embodiment, in addition to supporting the rifle 16 with the supports 52 and 56, another rifle is supported with the supports 54 and 50 in a manner substantially similar to the manner by which the rife 16 is supported with the supports 52 and 56, respectively.

In an exemplary embodiment, the caps 22da and 24da reduce the likelihood of the respective hook portions 22d and 24d from scratching or otherwise damaging the portion 12a of the cab 12 during the installation of the apparatus 10 and its support of the rifle 16. Likewise, the respective caps of the arms 38 and 40 reduce the likelihood of the respective hook portions from scratching or otherwise damaging the portion 12b of the cab 12 during the installation of the apparatus 10 and its support of the rifle 16.

In an exemplary embodiment, to quickly remove or uncouple the apparatus 10 from the cab 12, one or both of the wing knobs 32 and 40 are rotated counterclockwise and loosened so that the apparatus 10 is no longer subjected to tension loading. The arms 22 and 24, and/or the arms 38 and 40, are then moved in a direction away from the frame 18 until the distance between respective outer tangential points of the portions 12a and 12b of the cab 12 is generally less than the distance between respective inner tangential points of the hook portion 22d of the arm 22 and the corresponding hook portion of the arm 38, and is generally less to the distance between respective inner tangential points of the hook portion 24d of the arm 24 and the corresponding hook portion of the arm 40. At this point, the apparatus 10 is then easily removed or uncoupled from the cab 12.

In an exemplary embodiment, as illustrated in FIG. 7 with continuing reference to FIGS. 1, 2, 3, 4, 5 and 6, during operation, when the apparatus 10 is removably coupled to a structure 64 including members or bars 64a and 64b spaced in a parallel relation, the arm assemblies 20 and 36 engage the bars 64a and 64b, respectively, in accordance with the foregoing. An adjustable distance 66 is defined between respective inner tangential points of the hook portion 22d of the arm 22 and the corresponding hook portion of the arm 38, which inner tangential points contact outer tangential points of the bars 64a and 64b, respectively. Similarly, an adjustable distance 68 is defined between respective inner tangential points of the hook portion 24d of the arm 24 and the corresponding hook portion of the arm 40, which inner tangential points contact outer tangential points of the bars 64a and 64b, respectively. Since the bars 64a and 64b are spaced in a parallel relation, the distances 66 and 68 are generally equal.

In an exemplary embodiment, if the spacing between the bars 64a and 64b is increased, then the distances 66 and 68 may be adjusted by loosening the wing knobs 32 and 48, telescoping the arms 22 and 38 further out of the sleeve 18c, and telescoping the arms 24 and 40 further out of the sleeve 18d, in accordance with the foregoing, in order for the apparatus 10 to accommodate the increased spacing between the bars 64a and 64b and be removably coupled to the structure 64, as shown in FIG. 7.

In an exemplary embodiment, if the spacing between the bars 64a and 64b is decreased, then the distances 66 and 68 may be adjusted by tightening the wing knobs 32 and 48, telescoping the arms 20 and 38 further into the sleeve 18c, and telescoping the arms 24 and 40 further into the sleeve 18d, in accordance with the foregoing, in order for the apparatus 10 to accommodate the decreased spacing between the bars 64a and 64b and be removably coupled to the structure 64.

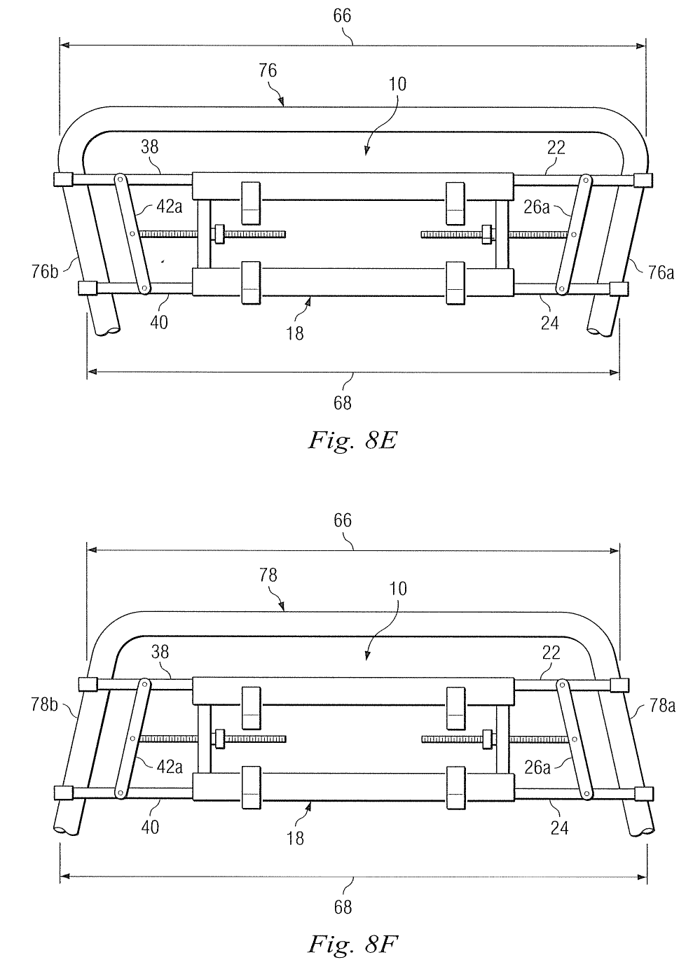

In an exemplary embodiment, as illustrated in FIG. 8A with continuing reference to FIGS. 1, 2, 3, 4, 5, 6 and 7, during operation, the apparatus 10 is removably coupled to a structure 70 including members or bars 70a and 70b spaced in a parallel relation. Since the bars 70a and 70b are spaced in a parallel relation, the distances 66 and 68 are generally equal. The frame 18 is centered between the bars 70a and 70b.

In an exemplary embodiment, as illustrated in FIG. 8B with continuing reference to FIGS. 1, 2, 3, 4, 5, 6, 7 and 8A, during operation, the apparatus 10 is removably coupled to the structure 70 and, since the bars 70a and 70b are spaced in a parallel relation, the distances 66 and 68 are generally equal. The frame 18 is not centered between the bars 70a and 70, but is instead positioned closer to the bar 70b because the extent to which the arms 38 and 40 are telescoped into the sleeves 18c and 18d, respectively, is greater than the extent to which the arms 22 and 24 are telescoped into the sleeves 18c and 18d, respectively.

In an exemplary embodiment, as illustrated in FIG. 8C with continuing reference to FIGS. 1, 2, 3, 4, 5, 6, 7, 8A and 8B, during operation, the apparatus 10 is removably coupled to a structure 72 including members or bars 72a and 72b. The bar 72a includes portions 72aa and 72ab, between which a jog portion 72ac extends. Similarly, the bar 72b includes portions 72ba and 72bb, between which a jog portion 72bc extends. The arms 22 and 24 engage the portions 72aa and 72ab, respectively. The arms 38 and 40 engage the portions 72ba and 72bb, respectively.

As shown in FIG. 8C, due to the jog portions 72ac and 72bc, the adjustable distance 66 is less than the adjustable distance 68. Since the adjustable distance 66 is independent of the adjustable distance 68 over at least a range of horizontal movement, as viewed in FIG. 8C, it is clear that a range of relative movement is permitted between the arms 22 and 24 of the arm assembly 20, and a range of relative movement is permitted between the arms 38 and 40 of the arm assembly 36.

More particularly, the link members 26a and 26b pivot together in a counterclockwise direction, as viewed in FIG. 8C, relative to the coupling 28 and about the longitudinal center axis of the internal passage 28a defined by the coupling 28, thereby permitting the arm 22 to telescope into the sleeve 18c to an extent greater than the extent to which the arm 24 telescopes into the sleeve 18d, thereby permitting relative horizontal movement between the arms 22 and 24, and thereby permitting the adjustable distance 66 to be adjusted independently of the adjustable distance 68, and vice versa. In several exemplary embodiments, the range of relative horizontal movement between the arms 22 and 24, as viewed in FIG. 8C, is defined by one or more of the following: the vertical spacing between the sleeves 18c and 18d; the horizontal spacing between the coupling 28 and the bar 18e; and the respective nominal gaps between the arm 22 and the sleeve 18c during the telescoping engagement therebetween, and between the arm 24 and the sleeve 18d during the telescoping engagement therebetween.

The link members 42a and 42b pivot together in a clockwise direction, as viewed in FIG. 8C, relative to the coupling 44 and about the longitudinal center axis of the internal passage (not shown) defined by the coupling 44, thereby permitting the arm 38 to telescope into the sleeve 18c to an extent greater than the extent to which the arm 40 telescopes into the sleeve 18d, thereby permitting relative horizontal movement between the arms 38 and 40, and thereby permitting the adjustable distance 66 to be adjusted independently of the adjustable distance 68, and vice versa. In several exemplary embodiments, the range of relative horizontal movement between the arms 38 and 40, as viewed in FIG. 8C, is defined by one or more of the following: the vertical spacing between the sleeves 18c and 18d; the horizontal spacing between the coupling 44 and the bar 18f; and the respective nominal gaps between the arm 38 and the sleeve 18c during the telescoping engagement therebetween, and between the arm 40 and the sleeve 18d during the telescoping engagement therebetween.

In an exemplary embodiment, as illustrated in FIG. 8D with continuing reference to FIGS. 1, 2, 3, 4, 5, 6, 7, 8A, 8B and 8C, during operation, the apparatus 10 is removable coupled to a structure 74 including members or bars 74a and 74b. The bar 74a includes portions 74aa and 74ab, between which a jog portion 74ac extends. Similarly, the bar 74b includes portions 74ba and 74bb, between which a jog portion 74bc extends. The arms 22 and 24 engage the portions 74aa and 74ab, respectively. The arms 38 and 40 engage the portions 74ba and 74bb, respectively.

As shown in FIG. 8D, due to the jog portions 74ac and 74bc, the adjustable distance 66 is greater than the adjustable distance 68. Since the adjustable distance 66 is independent of the adjustable distance 68 over at least a range of horizontal movement, as viewed in FIG. 8D, it is clear that a range of relative movement is permitted between the arms 22 and 24 of the arm assembly 20, and a range of relative movement is permitted between the arms 38 and 40 of the arm assembly 36.

More particularly, the link members 26a and 26b pivot together in a clockwise direction, as viewed in FIG. 8D, relative to the coupling 28 and about the longitudinal center axis of the internal passage 28a defined by the coupling 28, thereby permitting the arm 24 to telescope into the sleeve 18d to an extent greater than the extent to which the arm 22 telescopes into the sleeve 18c, thereby permitting relative horizontal movement between the arms 22 and 24, and thereby permitting the adjustable distance 68 to be adjusted independently of the adjustable distance 66, and vice versa. In several exemplary embodiments, the range of relative horizontal movement between the arms 22 and 24, as viewed in FIG. 8D, is defined by one or more of the following: the vertical spacing between the sleeves 18c and 18d; the horizontal spacing between the coupling 28 and the bar 18e; and the respective nominal gaps between the arm 22 and the sleeve 18c during the telescoping engagement therebetween, and between the arm 24 and the sleeve 18d during the telescoping engagement therebetween.

The link members 42a and 42b pivot together in a counterclockwise direction, as viewed in FIG. 8D, relative to the coupling 44 and about the longitudinal center axis of the internal passage (not shown) defined by the coupling 44, thereby permitting the arm 40 to telescope into the sleeve 18d to an extent greater than the extent to which the arm 38 telescopes into the sleeve 18c, thereby permitting relative horizontal movement between the arms 38 and 40, and thereby permitting the adjustable distance 68 to be adjusted independently of the adjustable distance 66, and vice versa. In several exemplary embodiments, the range of relative horizontal movement between the arms 38 and 40, as viewed in FIG. 8D, is defined by one or more of the following: the vertical spacing between the sleeves 18c and 18d; the horizontal spacing between the coupling 44 and the bar 18f; and the respective nominal gaps between the arm 38 and the sleeve 18c during the telescoping engagement therebetween, and between the arm 40 and the sleeve 18d during the telescoping engagement therebetween.

In an exemplary embodiment, as illustrated in FIG. 8E with continuing reference to FIGS. 1, 2, 3, 4, 5, 6, 7, 8A, 8B, 8C and 8D, during operation, the apparatus 10 is removable coupled to a structure 76 including angularly-extending members or bars 76a and 76b, which bars extend angularly downward and towards each other. The arms 22 and 24 engage the bar 76a, and the arms 38 and 40 engage the bar 76b. As shown in FIG. 8E, since the bars 76a and 76b extend angularly downward and towards each other, the adjustable distance 66 is greater than the adjustable distance 68. Since the adjustable distance 66 is independent of the adjustable distance 68 over at least a range of horizontal movement, as viewed in FIG. 8E, it is clear that a range of relative movement is permitted between the arms 22 and 24 of the arm assembly 20, and a range of relative movement is permitted between the arms 38 and 40 of the arm assembly 36, for substantially the same reasons as described above in connection with the exemplary embodiment illustrated in FIG. 8D.

In an exemplary embodiment, as illustrated in FIG. 8F with continuing reference to FIGS. 1, 2, 3, 4, 5, 6, 7, 8A, 8B, 8C, 8D and 8E, during operation, the apparatus 10 is removable coupled to a structure 78 including angularly-extending members or bars 78a and 78b, which bars extend angularly upward and towards each other. The arms 22 and 24 engage the bar 78a, and the arms 38 and 40 engage the bar 78b. As shown in FIG. 8F, since the bars 78a and 78b extend angularly upward and towards each other, the adjustable distance 66 is less than the adjustable distance 68. Since the adjustable distance 66 is independent of the adjustable distance 68 over at least a range of horizontal movement, as viewed in FIG. 8F, it is clear that a range of relative movement is permitted between the arms 22 and 24 of the arm assembly 20, and a range of relative movement is permitted between the arms 38 and 40 of the arm assembly 36, for substantially the same reasons as described above in connection with the exemplary embodiment illustrated in FIG. 8C.

In several exemplary embodiments, instead of, or in addition to the rifle 16, the apparatus 10 supports a wide variety of other objects such as, for example, all other types of guns, bows, ladders, tools, treestands, other work and/or recreational equipment, and/or any combination thereof.

In several exemplary embodiments, instead of, or in addition to one or more of the supports 50, 52, 54 and 56, one or more other supports are coupled to the frame 18 and are configured to support a wide variety of objects such as, for example, all other types of guns, bows, ladders, tools, treestands, other work and/or recreational equipment, and/or any combination thereof.

In several exemplary embodiments, instead of, or in addition to using fasteners, one or more of the supports 50, 52, 54 and 56 may be coupled to the frame 18, removably or otherwise, using a wide variety of techniques such as using snap-fit connections, using weld joints, forming the supports integrally with the frame, and/or any combination thereof.

In several exemplary embodiments, instead of, or in addition to the cab 12 of the UTV 14, the apparatus 10 is removably coupled to other portions of the UTV 14, such as the bed of the UTV 14.

In several exemplary embodiments, instead of, or in addition to the cab 12 of the UTV 14, the apparatus 10 is removably coupled to a wide variety of other movable and/or stationary structures such as, for example, trucks, cars, boats, sheds, other buildings, walls, work benches, and/or any combination thereof.

In several exemplary embodiments, the number of arms in one or more of the arm assemblies 20 and 36 is increased to three or more arms. In several exemplary embodiments, the arms 22 and 38 may be removed from the apparatus 10. In several exemplary embodiments, the arms 24 and 40 may be removed from the apparatus 10.

In several exemplary embodiments, the apparatus 10 is oriented, and one or more of the arms 22, 24, 38 and 40 extend, horizontally, vertically, angularly, and/or any combination thereof.

An apparatus adapted to be removably coupled to first and second members has been described that includes a frame defining opposing end portions and comprising first and second sleeves spaced in a parallel relation; one or more supports coupled to the frame for at least partially supporting an object; and a first pair of arms spaced in a parallel relation and coupled together, the first pair of arms being telescopingly engaged with the first and second sleeves, respectively, at one of the opposing end portions of the frame, the first pair of arms being movable relative to the frame, at least one arm in the first pair of arms being adapted to be removably coupled to the first member. In an exemplary embodiment, the apparatus comprises a second pair of arms spaced in a parallel relation, the second pair of arms being telescopingly engaged with the first and second members, respectively, at the other of the opposing end portions of the frame, the second pair of arms being movable relative to the frame, at least one arm in the second pair of arms being adapted to be removably coupled the second member. In an exemplary embodiment, when the apparatus is removably coupled to the first and second members, the respective arms in the first and second pairs of arms that are telescopingly engaged with the first sleeve define a first distance that is generally equal to a second distance defined by the first and second members. In an exemplary embodiment, when the apparatus is removably coupled to the first and second members, the respective arms in the first and second pairs of arms that are telescopingly engaged with the second sleeve define a third distance that is generally equal to either the second distance defined by the first and second members or a fourth distance defined by the first and second members. In an exemplary embodiment, the apparatus comprises a first pair of link members, each of the link members in the first pair of link members being coupled to the arms in the first pair of arms; a first coupling extending between and coupled to the link members in the first pair of link members; and a first threaded rod extending from the first coupling and coupled to the frame; wherein a range of relative movement between the arms in the first pair of arms is permitted; and wherein the link members in the first pair of link members rotate, relative to the first coupling, in response to any relative movement between the arms in the first pair of arms. In an exemplary embodiment, the frame further comprises a first bar through which the first threaded rod extends; and wherein the apparatus further comprises a first wing knob threadably engaged with the first threaded rod to thereby couple the first threaded rod to the frame, wherein the first bar is disposed between the first wing knob and the first coupling. In an exemplary embodiment, the apparatus comprises a second pair of arms spaced in a parallel relation, the second pair of arms being telescopingly engaged with the first and second members, respectively, at the other of the opposing end portions of the frame, the second pair of arms being movable relative to the frame, at least one arm in the second pair of arms being adapted to be removably coupled the second member; a second pair of link members, each of the link members in the second pair of link members being coupled to the arms in the second pair of arms; a second coupling extending between and coupled to the link members in the second pair of link members; and a second threaded rod extending from the second coupling and coupled to the frame; wherein the frame further comprises a second bar through which the second threaded rod extends; wherein the apparatus further comprises a second wing knob threadably engaged with the second threaded rod to thereby couple the second threaded rod to the frame, wherein the second bar is disposed between the second wing knob and the second coupling; wherein a range of relative movement between the arms in the second pair of arms is permitted; and wherein the link members in the second pair of link members rotate, relative to the second coupling, in response to any relative movement between the arms in the second pair of arms. In an exemplary embodiment, each arm in the first pair of arms comprises a horizontally-extending portion telescopingly engaged with one of the first and second sleeves of the frame; an angular portion extending from the horizontally-extending portion; and a hook-shaped portion extending from the angular portion. In an exemplary embodiment, the apparatus comprises a first pair of link members, each of the link members in the first pair of link members being coupled to the arms in the first pair of arms; a first coupling extending between and coupled to the link members in the first pair of link members; a first threaded rod extending from the first coupling and coupled to the frame; a second pair of arms spaced in a parallel relation, the second pair of arms being telescopingly engaged with the first and second members, respectively, at the other of the opposing end portions of the frame, the second pair of arms being movable relative to the frame, at least one arm in the second pair of arms being adapted to be removably coupled the second member; a second pair of link members, each of the link members in the second pair of link members being coupled to the arms in the second pair of arms; a second coupling extending between and coupled to the link members in the second pair of link members; and a second threaded rod extending from the second coupling and coupled to the frame; wherein a range of relative movement between the arms in the first pair of arms is permitted; wherein the link members in the first pair of link members rotate, relative to the first coupling, in response to any relative movement between the arms in the first pair of arms; wherein a range of relative movement between the arms in the second pair of arms is permitted; wherein the link members in the second pair of link members rotate, relative to the second coupling, in response to any relative movement between the arms in the second pair of arms; wherein the frame further comprises a first bar through which the first threaded rod extends; and a second bar through which the second threaded rod extends; wherein the apparatus further comprises a first wing knob threadably engaged with the first threaded rod to thereby couple the first threaded rod to the frame, wherein the first bar is disposed between the first wing knob and the first coupling; and a second wing knob threadably engaged with the second threaded rod to thereby couple the second threaded rod to the frame, wherein the second bar is disposed between the second wing knob and the second coupling; wherein each arm in the first and second pairs of arms comprises a horizontally-extending portion telescopingly engaged with one of the first and second sleeves of the frame an angular portion extending from the horizontally-extending portion; and a hook-shaped portion extending from the angular portion; and wherein, when the apparatus is removably coupled to the first and second members, the respective arms in the first and second pairs of arms that are telescopingly engaged with the first sleeve define a first distance that is generally equal to a second distance defined by the first and second members; and the respective arms in the first and second pairs of arms that are telescopingly engaged with the second sleeve define a third distance that is generally equal to either the second distance defined by the first and second members or a fourth distance defined by the first and second members.

An apparatus adapted to be removably coupled to a structure comprising first and second members, the first and second members defining a first distance, has been described that includes a frame defining opposing end portions and comprising a first sleeve; a first arm telescopingly engaged with the first sleeve at one of the opposing end portions of the frame, the first arm being movable relative to the frame, the first arm comprising an angular portion; and a hook-shaped portion extending from the angular portion and adapted to engage the first member; a second arm telescopingly engaged with the first sleeve at the other of the opposing end portions of the frame, the second arm being movable relative to the frame, the second arm comprising an angular portion; and a hook-shaped portion extending from the angular portion and adapted to engage the second member; and one or more supports coupled to the frame for at least partially supporting an object; wherein the first and second arms define an adjustable distance, the adjustable distance being generally equal to the first distance defined by the first and second members when the apparatus is removably coupled to the structure; and wherein the respective angular portions of the first and second arms provide an offset between the frame and at least a portion of the structure when the apparatus is removably coupled to the structure.

A method has been described that includes providing a carrier; and removably coupling the carrier to a structure, comprising engaging the carrier with the structure; and subjecting the carrier to tension loading after engaging the carrier with the structure. In an exemplary embodiment, the carrier comprises a frame; and wherein the method further comprises supporting an object using the carrier, comprising coupling one or more supports to the frame; and at least partially supporting the object using the one or more supports. In an exemplary embodiment, the structure defines a first distance; wherein the carrier defines at least one adjustable distance; and wherein engaging the carrier with the structure comprises adjusting the at least one adjustable distance so that the at least one adjustable distance is generally equal to the first distance defined by the structure. In an exemplary embodiment, the structure defines a second distance; wherein the carrier defines at least one other adjustable distance; and wherein engaging the carrier with the structure further comprises adjusting the at least one other adjustable distance so that the at least one other adjustable distance is generally equal to the second distance defined by the structure. In an exemplary embodiment, the carrier comprises a sleeve and first and second arms; wherein engaging the carrier with the structure further comprises telescopingly engaging at least one of the first and second arms with the sleeve; and engaging the first and second arms with the structure; and wherein subjecting the carrier to tension loading after engaging the carrier with the structure comprises urging the at least one of the first and second arms to telescope further into the sleeve after engaging the first and second arms with the structure.

A system has been described that includes means for providing a carrier; and means for removably coupling the carrier to a structure, comprising means for engaging the carrier with the structure; and means for subjecting the carrier to tension loading after engaging the carrier with the structure. In an exemplary embodiment, the carrier comprises a frame; and wherein the system further comprises means for supporting an object using the carrier, comprising means for coupling one or more supports to the frame; and means for at least partially supporting the object using the one or more supports. In an exemplary embodiment, the structure defines a first distance; wherein the carrier defines at least one adjustable distance; and wherein means for engaging the carrier with the structure comprises means for adjusting the at least one adjustable distance so that the at least one adjustable distance is generally equal to the first distance defined by the structure. In an exemplary embodiment, the structure defines a second distance; wherein the carrier defines at least one other adjustable distance; and wherein means for engaging the carrier with the structure further comprises means for adjusting the at least one other adjustable distance so that the at least one other adjustable distance is generally equal to the second distance defined by the structure. In an exemplary embodiment, the carrier comprises a sleeve and first and second arms; wherein means for engaging the carrier with the structure further comprises means for telescopingly engaging at least one of the first and second arms with the sleeve; and means for engaging the first and second arms with the structure; and wherein means for subjecting the carrier to tension loading after engaging the carrier with the structure comprises means for urging the at least one of the first and second arms to telescope further into the sleeve after engaging the first and second arms with the structure.

It is understood that variations may be made in the foregoing without departing from the scope of the disclosure.

Any spatial references such as, for example, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “top,” “bottom,” “clockwise,” “counterclockwise,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. Apparatus adapted to be removably coupled to first and second members, the apparatus comprising:
a frame defining opposing end portions and comprising first and second sleeves spaced in a parallel relation;
one or more supports coupled to the frame for at least partially supporting an object; and
a first pair of arms spaced in a parallel relation and coupled together, the first pair of arms being telescopingly engaged with the first and second sleeves, respectively, at one of the opposing end portions of the frame, the first pair of arms being movable relative to the frame, at least one arm in the first pair of arms being adapted to be removably coupled to the first member.

2. The apparatus of claim 1 further comprising:
a second pair of arms spaced in a parallel relation, the second pair of arms being telescopingly engaged with the first and second members, respectively, at the other of the opposing end portions of the frame, the second pair of arms being movable relative to the frame, at least one arm in the second pair of arms being adapted to be removably coupled the second member.

3. The apparatus of claim 2 wherein, when the apparatus is removably coupled to the first and second members, the respective arms in the first and second pairs of arms that are telescopingly engaged with the first sleeve define a first distance that is generally equal to a second distance defined by the first and second members.

4. The apparatus of claim 3 wherein, when the apparatus is removably coupled to the first and second members, the respective arms in the first and second pairs of arms that are telescopingly engaged with the second sleeve define a third distance that is generally equal to either the second distance defined by the first and second members or a fourth distance defined by the first and second members.

5. The apparatus of claim 1 further comprising:
a first pair of link members, each of the link members in the first pair of link members being coupled to the arms in the first pair of arms;
a first coupling extending between and coupled to the link members in the first pair of link members; and
a first threaded rod extending from the first coupling and coupled to the frame;
wherein a range of relative movement between the arms in the first pair of arms is permitted; and
wherein the link members in the first pair of link members rotate, relative to the first coupling, in response to any relative movement between the arms in the first pair of arms.

6. The apparatus of claim 5 wherein the frame further comprises:
a first bar through which the first threaded rod extends; and
wherein the apparatus further comprises:
a first wing knob threadably engaged with the first threaded rod to thereby couple the first threaded rod to the frame, wherein the first bar is disposed between the first wing knob and the first coupling.

7. The apparatus of claim 6 further comprising:
a second pair of arms spaced in a parallel relation, the second pair of arms being telescopingly engaged with the first and second members, respectively, at the other of the opposing end portions of the frame, the second pair of arms being movable relative to the frame, at least one arm in the second pair of arms being adapted to be removably coupled the second member;
a second pair of link members, each of the link members in the second pair of link members being coupled to the arms in the second pair of arms;
a second coupling extending between and coupled to the link members in the second pair of link members; and
a second threaded rod extending from the second coupling and coupled to the frame;
wherein the frame further comprises:
a second bar through which the second threaded rod extends;
wherein the apparatus further comprises:
a second wing knob threadably engaged with the second threaded rod to thereby couple the second threaded rod to the frame, wherein the second bar is disposed between the second wing knob and the second coupling;
wherein a range of relative movement between the arms in the second pair of arms is permitted; and
wherein the link members in the second pair of link members rotate, relative to the second coupling, in response to any relative movement between the arms in the second pair of arms.

8. The apparatus of claim 1 wherein each arm in the first pair of arms comprises:
a horizontally-extending portion telescopingly engaged with one of the first and second sleeves of the frame;
an angular portion extending from the horizontally-extending portion; and
a hook-shaped portion extending from the angular portion.

9. The apparatus of claim 1 further comprising:
a first pair of link members, each of the link members in the first pair of link members being coupled to the arms in the first pair of arms;
a first coupling extending between and coupled to the link members in the first pair of link members;
a first threaded rod extending from the first coupling and coupled to the frame;
a second pair of arms spaced in a parallel relation, the second pair of arms being telescopingly engaged with the first and second members, respectively, at the other of the opposing end portions of the frame, the second pair of arms being movable relative to the frame, at least one arm in the second pair of arms being adapted to be removably coupled the second member;
a second pair of link members, each of the link members in the second pair of link members being coupled to the arms in the second pair of arms;
a second coupling extending between and coupled to the link members in the second pair of link members; and
a second threaded rod extending from the second coupling and coupled to the frame;
wherein a range of relative movement between the arms in the first pair of arms is permitted;
wherein the link members in the first pair of link members rotate, relative to the first coupling, in response to any relative movement between the arms in the first pair of arms;
wherein a range of relative movement between the arms in the second pair of arms is permitted;
wherein the link members in the second pair of link members rotate, relative to the second coupling, in response to any relative movement between the arms in the second pair of arms;
wherein the frame further comprises:
a first bar through which the first threaded rod extends; and
a second bar through which the second threaded rod extends;
wherein the apparatus further comprises:
a first wing knob threadably engaged with the first threaded rod to thereby couple the first threaded rod to the frame, wherein the first bar is disposed between the first wing knob and the first coupling; and
a second wing knob threadably engaged with the second threaded rod to thereby couple the second threaded rod to the frame, wherein the second bar is disposed between the second wing knob and the second coupling;
wherein each arm in the first and second pairs of arms comprises:
a horizontally-extending portion telescopingly engaged with one of the first and second sleeves of the frame;
an angular portion extending from the horizontally-extending portion; and
a hook-shaped portion extending from the angular portion; and
wherein, when the apparatus is removably coupled to the first and second members,
the respective arms in the first and second pairs of arms that are telescopingly engaged with the first sleeve define a first distance that is generally equal to a second distance defined by the first and second members; and
the respective arms in the first and second pairs of arms that are telescopingly engaged with the second sleeve define a third distance that is generally equal to either the second distance defined by the first and second members or a fourth distance defined by the first and second members.

10. Apparatus adapted to be removably coupled to a structure comprising first and second members, the first and second members defining a first distance, the apparatus comprising:
a frame defining opposing end portions and comprising a first sleeve;
a first arm telescopingly engaged with the first sleeve at one of the opposing end portions of the frame, the first arm being movable relative to the frame, the first arm comprising:
an angular portion; and
a hook-shaped portion extending from the angular portion and adapted to engage the first member;
a second arm telescopingly engaged with the first sleeve at the other of the opposing end portions of the frame, the second arm being movable relative to the frame,
the second arm comprising:
an angular portion; and
a hook-shaped portion extending from the angular portion and adapted to engage the second member; and
one or more supports coupled to the frame for at least partially supporting an object;
wherein the first and second arms define an adjustable distance, the adjustable distance being generally equal to the first distance defined by the first and second members when the apparatus is removably coupled to the structure; and
wherein the respective angular portions of the first and second arms provide an offset between the frame and at least a portion of the structure when the apparatus is removably coupled to the structure.

11. A method comprising:
providing a carrier; and
removably coupling the carrier to a structure, comprising:
engaging the carrier with the structure; and
subjecting the carrier to tension loading after engaging the carrier with the structure.

12. The method of claim 11 wherein the carrier comprises a frame; and
wherein the method further comprises:
supporting an object using the carrier, comprising:
coupling one or more supports to the frame; and
at least partially supporting the object using the one or more supports.

13. The method of claim 11 wherein the structure defines a first distance;
wherein the carrier defines at least one adjustable distance; and
wherein engaging the carrier with the structure comprises:
adjusting the at least one adjustable distance so that the at least one adjustable distance is generally equal to the first distance defined by the structure.

14. The method of claim 13 wherein the structure defines a second distance;
wherein the carrier defines at least one other adjustable distance; and
wherein engaging the carrier with the structure further comprises:
adjusting the at least one other adjustable distance so that the at least one other adjustable distance is generally equal to the second distance defined by the structure.

15. The method of claim 13 wherein the carrier comprises a sleeve and first and second arms;
wherein engaging the carrier with the structure further comprises:
telescopingly engaging at least one of the first and second arms with the sleeve; and
engaging the first and second arms with the structure; and
wherein subjecting the carrier to tension loading after engaging the carrier with the structure comprises:
urging the at least one of the first and second arms to telescope further into the sleeve after engaging the first and second arms with the structure.

16. A system comprising:
means for providing a carrier; and
means for removably coupling the carrier to a structure, comprising:
means for engaging the carrier with the structure; and
means for subjecting the carrier to tension loading after engaging the carrier with the structure.

17. The system of claim 16 wherein the carrier comprises a frame; and
wherein the system further comprises:
means for supporting an object using the carrier, comprising:
means for coupling one or more supports to the frame; and
means for at least partially supporting the object using the one or more supports.

18. The system of claim 16 wherein the structure defines a first distance;
wherein the carrier defines at least one adjustable distance; and
wherein means for engaging the carrier with the structure comprises:
means for adjusting the at least one adjustable distance so that the at least one adjustable distance is generally equal to the first distance defined by the structure.

19. The system of claim 18 wherein the structure defines a second distance;
wherein the carrier defines at least one other adjustable distance; and
wherein means for engaging the carrier with the structure further comprises:
means for adjusting the at least one other adjustable distance so that the at least one other adjustable distance is generally equal to the second distance defined by the structure.

20. The system of claim 18 wherein the carrier comprises a sleeve and first and second arms;
wherein means for engaging the carrier with the structure further comprises:
means for telescopingly engaging at least one of the first and second arms with the sleeve; and
means for engaging the first and second arms with the structure; and
wherein means for subjecting the carrier to tension loading after engaging the carrier with the structure comprises:
means for urging the at least one of the first and second arms to telescope further into the sleeve after engaging the first and second arms with the structure.
